(19) United States
(12) Patent Application Publication
(10) Pub. No.: US 2005/0258316 A1
(43) Pub. Date: Nov. 24, 2005

(54) Stand post for lamps

(76) Inventors: Liang-An Lin, Taichung Hsien (TW); Chin-Hui Chen, Taichung Hsien (TW)

Correspondence Address: OSTROLENK FABER GERB & SOFFEN, 1180 AVENUE OF THE AMERICAS, NEW YORK, NY, 100368403, US

(21) Appl. No.: 10/903,368

(22) Filed: Jul. 30, 2004

(30) Foreign Application Priority Data
May 20, 2004 (TW) 093207910

(51) Int. Cl. F16M 11/00

(52) U.S. Cl. 248/127

(57) ABSTRACT

A stand post includes an outer tube defining an inner space therein and having upper and lower open ends that define respectively upper and lower openings in the outer tube, a rigid inner tube disposed in the inner space, defining a wire-passage therein for passage of a conductive wire therethrough, and having upper and lower threaded ends, a filler filling in an annular gap between the inner and outer tubes, and upper and lower cap units that are mounted respectively on the upper and lower open ends of the outer tube and that engage threadedly and respectively the upper and lower threaded ends of the inner tube.

### CROSS-REFERENCE TO RELATED APPLICATION

This application claims priority of Taiwanese patent application. No. 093207910, filed on May 20, 2004.

### BACKGROUND OF THE INVENTION

1. Field of the Invention

This invention relates to a stand post suitable for application to a lamp, more particularly to a stand post having a rigid inner tube mounted in an outer tube for increasing the mechanical strength of the stand post.

2. Description of the Related Art

FIGS. 1 and 2 illustrate a conventional stand post 1 suitable for application to a lamp (not shown) . The conventional stand post 1 includes a tubular member 11 that defines an inner space therein and that is made from a paper tube, a filler layer 13 that is made from wood waste, such as wood shavings and wood pieces, and that fills in the inner space, a plug member 12 that plugs a lower opening in the tubular member 11, and a decorative sheet 14 that is wrapped around an outer surface of the tubular member 11. A wire-passage 15 is formed by drilling in the filler layer 13 to permit passage of a conductive wire (not shown) therethrough.

Since the tubular member 11 is made from a paper tube, and the filler layer 13 is made from wood waste in view of environmental concerns, the mechanical strength of the stand post 1 is not strong enough. In addition, drilling of the wire-passage 15 in the filler layer 13 is relatively inconvenient and time-consuming.

### SUMMARY OF THE INVENTION

Therefore, the object of the present invention is to provide a stand post that is capable of overcoming the aforesaid drawbacks associated with the prior art.

According to this invention, there is provided a stand post suitable for application to a lamp. The stand post comprises: an outer tube defining an inner space therein and having upper and lower open ends that are axially opposite to each other and that define respectively upper and lower openings in the outer tube; a rigid inner tube disposed co-axially in the inner space, defining a wire-passage therein for passage of a conductive wire therethrough, and having upper and lower threaded ends that are disposed respectively adjacent to the upper and lower openings of the outer tube, the inner and outer tubes cooperatively defining an annular gap therebetween; a filler filling in the annular gap; and upper and lower cap units that are mounted respectively on the upper and lower open ends of the outer tube, that extend respectively through the upper and lower openings in the outer tube and into the inner space, and that engage threadedly and respectively the upper and lower threaded ends of the inner tube so as to abut respectively against the upper and lower open ends of the outer tube and to secure the inner tube to the outer tube when the upper and lower cap units are tightened on the inner tube.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional stand post;

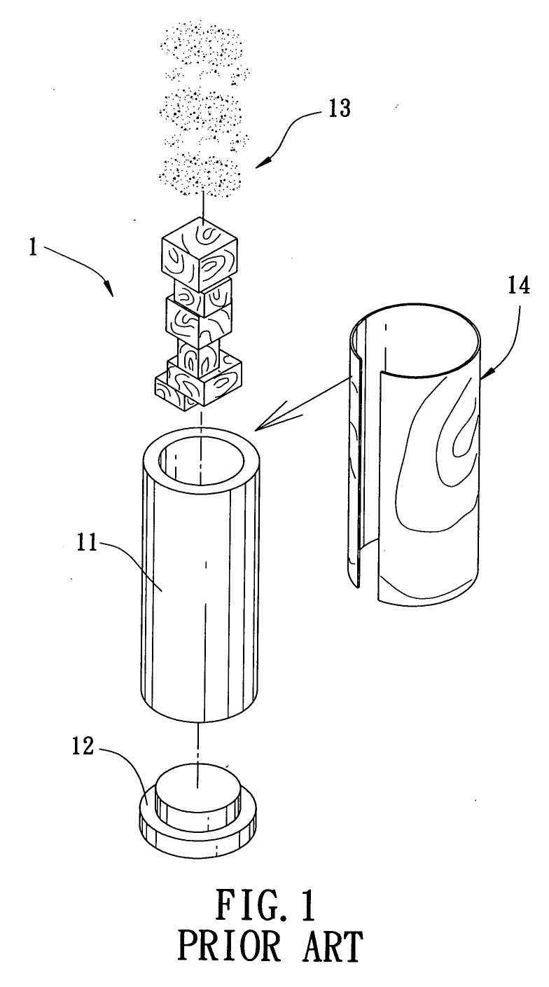

FIG. 2 is a sectional view of the conventional stand post;

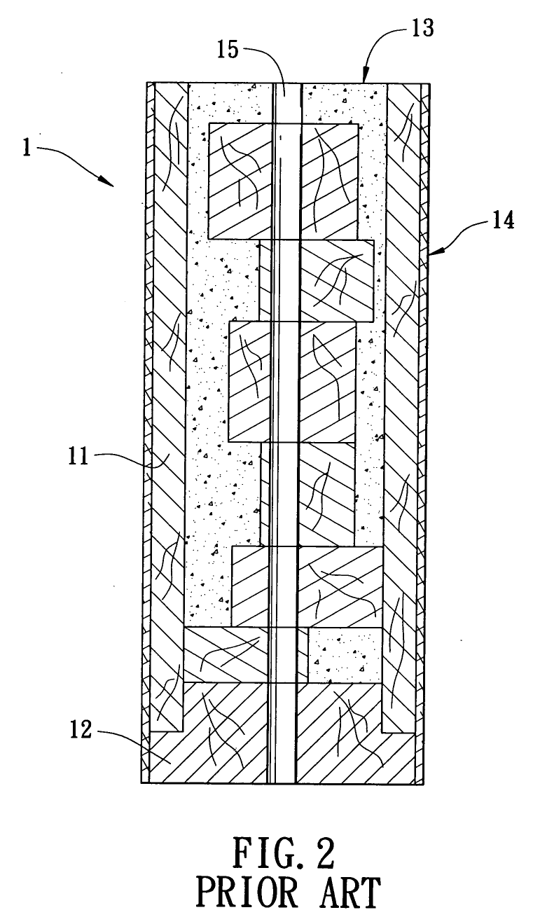

FIG. 3 is an exploded perspective view of the first preferred embodiment of a stand post according to this invention;

FIG. 4 is a sectional view of the first preferred embodiment of this invention;

FIG. 5 is an exploded perspective view of the second preferred embodiment according to this invention;

FIG. 6 is a fragmentary sectional view of the third preferred embodiment according to this invention;

FIG. 7 is a perspective view to illustrate how the stand post of this invention, which has a hexagonal cross-section, is connected to a base and a bulb-seat of a lamp; and

FIG. 8 is a perspective view to illustrate how the stand post of this invention, which has a curved shape, is connected to the base and the bulb-seat of the lamp.

### DETAILED DESCRIPTION OF THE PREFERRED EMBODIMENTS

Before the present invention is described in greater detail, it should be noted that same reference numerals have been used to denote like elements throughout the specification.

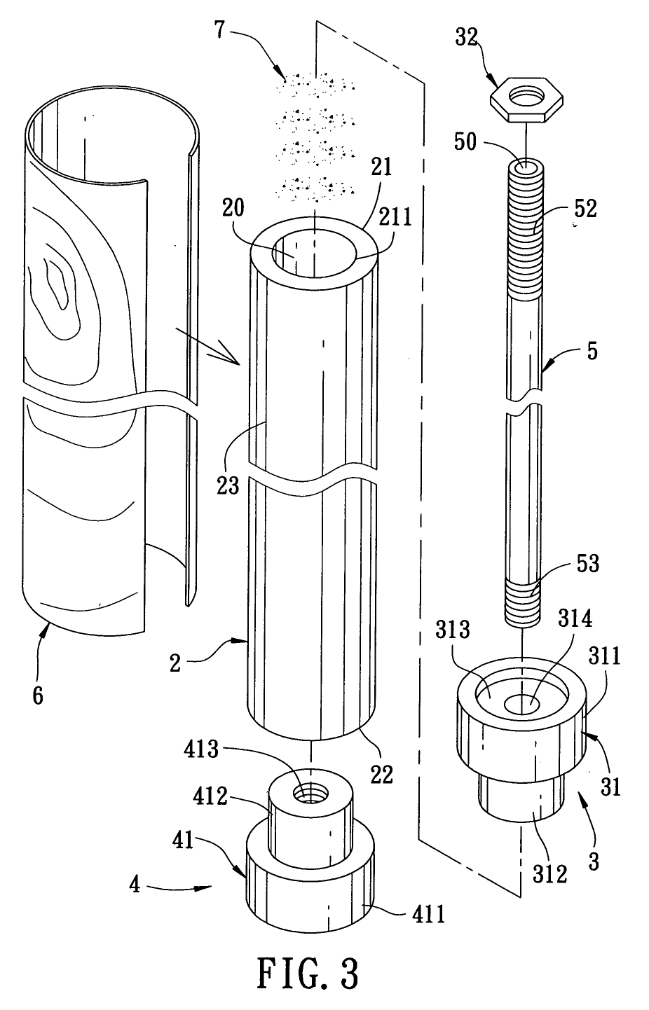

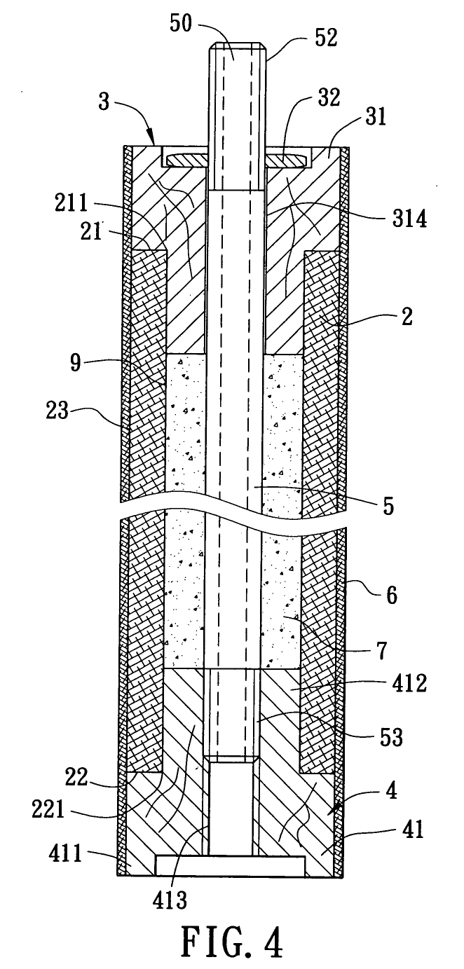

FIGS. 3 and 4 illustrate the first preferred embodiment of a stand post suitable for application to a lamp (not shown) according to the present invention.

The stand post includes: an outer tube 2 defining an inner space 20 therein and having upper and lower open ends 21, 22 that are axially opposite to each other and that define respectively upper and lower openings 211, 221 in the outer tube 2; a rigid inner tube 5 disposed co-axially in the inner space 20, defining a wire-passage 50 therein for passage of a conductive wire (not shown) therethrough, and having upper and lower threaded ends 52, 53 that are disposed respectively adjacent to the upper and lower openings 211, 221 in the outer tube 2, the inner and outer tubes 5, 2 cooperatively defining an annular gap 9 therebetween; a filler 7 filling in the annular gap 9; and upper and lower cap units 3, 4 that are mounted respectively on the upper and lower open ends 21, 22 of the outer tube 2, that extend respectively through the upper and lower openings 211, 221 in the outer tube 2, and that engage threadedly and respectively the upper and lower threaded ends 52, 53 of the inner tube 5 so as to abut respectively against the upper and lower open ends 21, 22 of the outer tube 2 and to secure the inner tube 5 to the outer tube 2 when the upper and lower cap units 3, 4 are tightened on the inner tube 5. In this embodiment, the lower cap unit 4 includes a lower cap member 41 that has a head portion 411 and an insertion portion 412 reduced in size from the head portion 411, extending axially from the head portion 411 through the lower opening 221 in the outer tube 2 and into the inner space 20 in the outer tube 2, and formed with an axially extending inner thread 413 which engages the lower threaded end 53 of the inner tube 5.

The upper cap unit 3 includes an upper cap member 31 that has a head portion 311 formed with a bore 313, and an insertion portion 312 reduced I nsize from the head portion 311 of the upper cap member 31, extending axially from the head portion 311 through the upper opening 211 in the outer tube 2 and into the inner space 20 in the outer tube 2, and formed with an axial through-hole 314 which is in spatial communication with the bore 313 in the head portion 311 of the upper cap member 31 for passage of the upper threaded end 52 of the inner tube 5 therethrough and into the bore 313 in the head portion 311 of the upper cap member 31. The upper cap unit 3 further includes a screw nut 32 that is received in the bore 313 in the head portion 311 of the upper cap member 31 and that engages threadedly the upper threaded end 52 of the inner tube 5 for tightening the upper cap unit 3 on the inner tube 5.

The outer tube 2 has a cylindrical outer surface 23. A decorative sheet 6 is wrapped around the outer surface 23 of the outer tube 2, and has a pattern, such as wood grain texture, so as to result in a pleasing appearance.

Preferably, the inner tube 5 is made from a metallic material. The filler 7 can be made from wood waste, a foamed resin material, or a cement material.

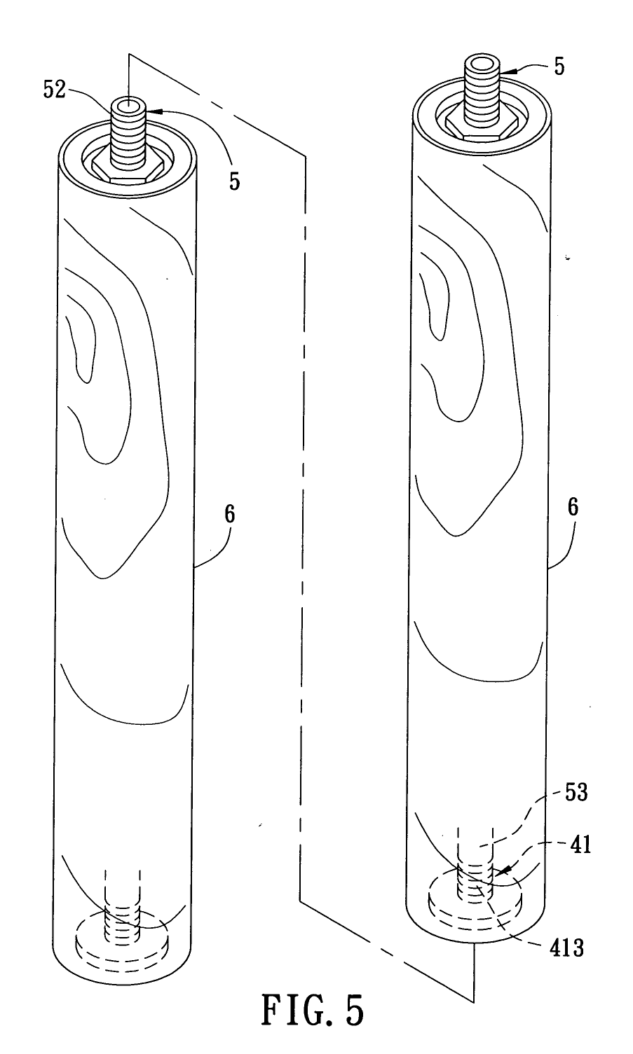

FIG. 5 illustrates the second preferred embodiment of the stand post according to this invention. In this embodiment two of the stand posts of the previous embodiment are connected to each other. Referring also to FIG. 4, the lower threaded end 53 of the inner tube 5 engages threadedly only a portion of the inner thread 413 of the lower cap member 41. As such, the remainder of the inner thread 413 of the lower cap member 41 of one of the stand posts can be used to connect to the upper threaded end 52 of the inner tube 5 of the other of the stand posts.

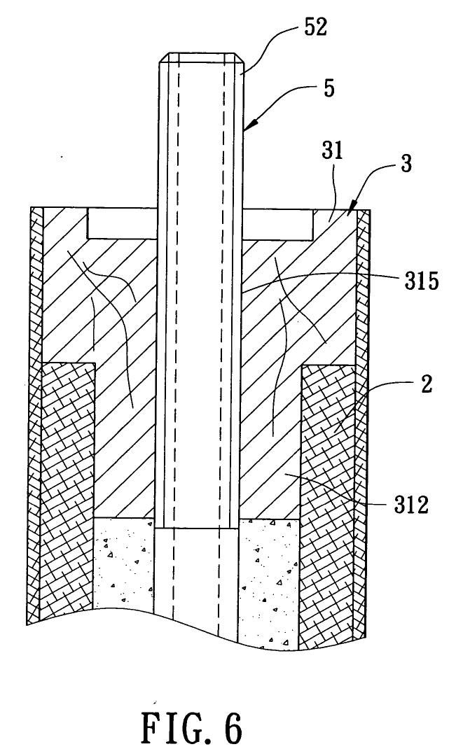

FIG. 6 illustrates the third preferred embodiment of the stand post according to this invention. The stand post of this embodiment differs from the first preferred embodiment in that the insertion portion 312 of the upper cap member 31 is formed with an axially extending inner thread 315 which engages the upper threaded end 52 of the inner tube 5. As such, the screw nut 32 used in the first preferred embodiment is not needed in this embodiment. It is noted that the upper and lower cap members 31, 41 can both be formed with the inner threads, such as the third embodiment shown in FIG. 6, so as to engage threadedly and respectively the upper and lower threaded ends 52, 53 of the inner tube 5, or formed with the through-holes 314 of the first embodiment for passage of the upper and lower threaded ends 52, 53 of the inner tube 5 therethrough to engage respectively two of the screw nuts 32.

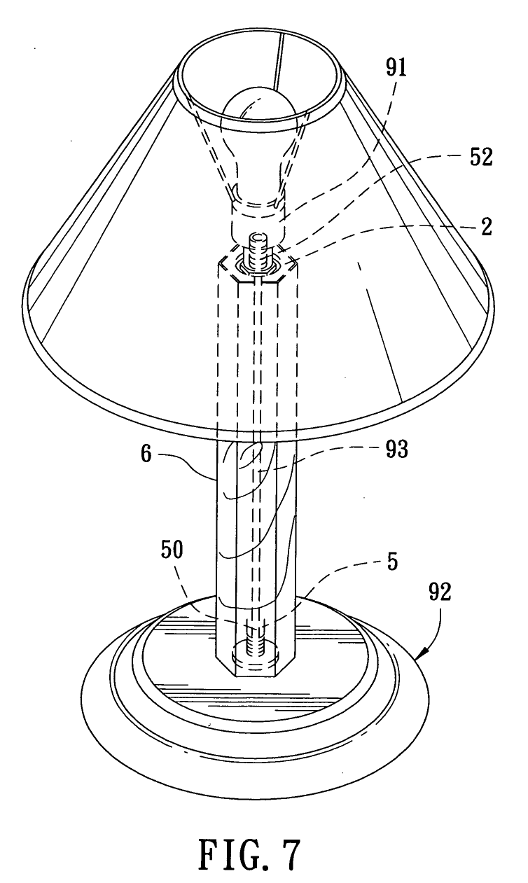

FIG. 7 illustrates how the stand post of this invention, which has a hexagonal cross-section, is connected to a base 92 and a bulb-seat 91 of a lamp. A conductive wire 93 is disposed in the wire-passage 50 in the inner tube 5.

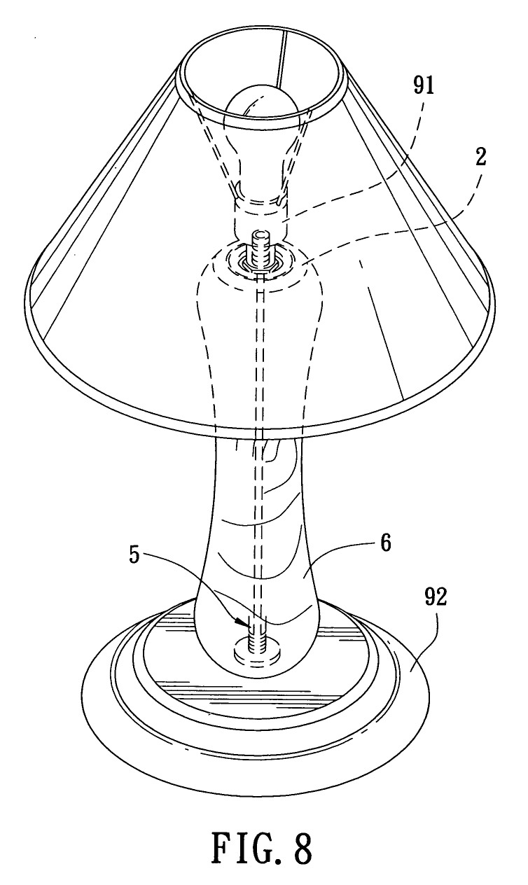

FIG. 8 illustrates the stand post which is modified from the stand post of FIG. 7 and which has a curved shape.

With the inclusion of the inner tube 5 and the upper and lower cap units 3, 4 in the stand post of this invention, the aforesaid drawbacks associated with the prior art can be eliminated.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A stand post comprising:
an outer tube defining an inner space therein and having upper and lower open ends that are axially opposite to each other and that define respectively upper and lower openings in said outer tube;
a rigid inner tube disposed co-axially in said inner space, defining a wire-passage therein for passage of a conductive wire therethrough, and having upper and lower threaded ends that are disposed respectively adjacent to said upper and lower openings in said outer tube, said inner and outer tubes cooperatively defining an annular gap therebetween;
a filler filling in said annular gap; and
upper and lower cap units that are mounted respectively on said upper and lower open ends of said outer tube, that extend respectively through said upper and lower openings in said outer tube and into said inner space, and that engage threadedly and respectively said upper and lower threaded ends of said inner tube so as to abut respectively against said upper and lower open ends of said outer tube and to secure said inner tube to said outer tube when said upper and lower cap units are tightened on said inner tube.

2. The stand post of claim 1, wherein said lower cap unit includes a lower cap member that has a head portion and an insertion portion reduced in size from said head portion, extending axially from said head portion through said lower opening in said outer tube and into said inner space in said outer tube, and formed with an axially extending inner thread which engages said lower threaded end of said inner tube.

3. The stand post of claim 2, wherein said upper cap unit includes an upper cap member that has a head portion formed with a bore, and an insertion portion reduced in size from said head portion of said upper cap member, extending axially from said head portion of said upper cap member through said upper opening in said outer tube and into said inner space in said outer tube, and formed with an axial through-hole which is in spatial communication with said bore in said head portion of said upper cap member for passage of said upper threaded end of said inner tube therethrough and into said bore in said head portion of said upper cap member, said upper cap unit further including a screw nut that is received in said bore in said head portion of said upper cap member and that engages threadedly said upper threaded end of said inner tube for tightening said upper cap unit on said inner tube.

4. The stand post of claim 1, wherein said outer tube has a cylindrical outer surface, said stand post further comprising a decorative sheet that is wrapped around said outer surface of said outer tube.

5. The stand post of claim 1, wherein said filler is made from wood waste.

6. The stand post of claim 1, wherein said filler is made from a foamed resin material.

7. The stand post of claim 1, wherein said filler is made from a cement material.

8. The stand post of claim 2, wherein said upper cap unit includes an upper cap member that has a head portion and an insertion portion reduced in size from said head portion of said upper cap member, extending axially from said head portion of said upper cap member through said upper opening in said outer tube and into said inner space in said outer tube, and formed with an axially extending inner thread which engages said upper threaded end of said inner tube.
